(19) United States
(12) Patent Application Publication
(10) Pub. No.: US 2005/0205603 A1
(43) Pub. Date: Sep. 22, 2005

(54) Holding and dispensing apparatus

(75) Inventor: Chien-Fu Lin, Feng Chia Li (TW)

Correspondence Address: NIKOLAI & MERSEREAU, P.A., 900 SECOND AVENUE SOUTH, SUITE 820, MINNEAPOLIS, MN, 55402, US

(73) Assignee: Aidox Technology Corporation, Taichung (TW)

(21) Appl. No.: 10/804,797

(22) Filed: Mar. 18, 2004

(51) Int. Cl. B67D 5/00

(52) U.S. Cl. 222/83

(57) ABSTRACT

A holding and dispensing apparatus is provided for use with a pack. The holding and dispensing apparatus includes a holding device for holding the pack and a dispensing device for dispensing beverage from the pack. The holding device includes a clamp for clamping the pack and a handle attached to the clamp. The clamp includes a first jaw for contact with the top of the pack and a second jaw for contact with the bottom of the pack. The first jaw is connected with the second jaw so that a distance between them is adjustable. Thus, the clamp can clamp packs of different heights. The handle is attached to a plate extending from the second jaw.

### FIELD OF INVENTION

The present invention relates to a beverage pack and, more particularly, to a holding and dispensing apparatus for use with a beverage pack.

### BACKGROUND OF INVENTION

Referring to FIG. 7, a conventional pack 90 includes a top 92, an aperture 93 defined in the top 92 and a lid 91 attached to the top 92 in order to seal the aperture 93. The lid 91 can be lifted so that beverage can be poured from the pack 90 through the aperture 93. However, the beverage cannot be poured smoothly because of the air pressure tends to seal the single aperture 93. As a result, the beverage can be spilt. In addition, moisture sticks to the pack 90 when it is taken from a refrigerator. In this case, the pack 90 becomes slippery and can be dropped easily.

The present invention is therefore intended to obviate or at least alleviate the problems encountered in prior art.

### SUMMARY OF INVENTION

It is the primary objective of the present invention to provide a holding and dispensing apparatus for use with a pack.

According to the present invention, a holding and dispensing apparatus is provided for use with a pack. The holding and dispensing apparatus includes a holding device for holding the pack and a dispensing device for dispensing beverage from the pack.

Other objects, advantages and novel features of the invention will become more apparent from the following detailed description in conjunction with the attached drawings.

### BRIEF DESCRIPTION OF DRAWINGS

The present invention will be described via detailed illustration of the preferred embodiment referring to the drawings.

FIG. 1 is an exploded view of a holding and dispensing apparatus according to the preferred embodiment of this invention.

FIG. 2 is a cross-sectional view of the holding and dispensing apparatus shown in FIG. 1.

FIG. 3 is similar to FIG. 2 but shows the holding and dispensing apparatus in another position.

FIG. 4 is similar to FIG. 3 but shows the holding and dispensing apparatus in another position.

FIG. 5 is a cross-sectional view of the holding and dispensing apparatus shown in FIG. 1 used with a pack shown in phantom lines.

FIG. 6 is similar to FIG. 1 but shows the holding and dispensing apparatus in another position.

FIG. 7 is a cross-sectional view of a conventional pack.

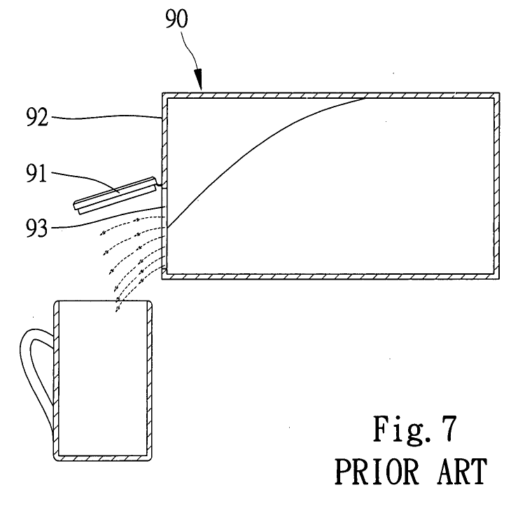

### DETAILED DESCRIPTION OF PREFERRED EMBODIMENT

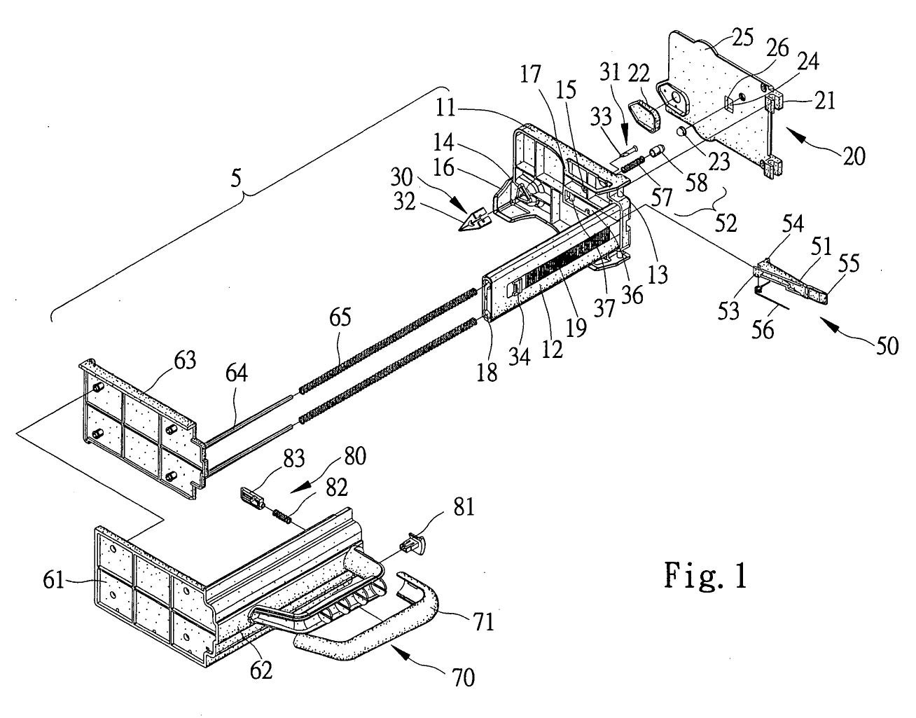

Referring to FIGS. 1-6, according to the preferred embodiment of the present invention, a holding and dispensing apparatus is provided for use with a pack 3. The holding and dispensing apparatus includes a holding device for holding the pack 3 and a dispensing device for dispensing beverage from the pack 3.

The holding device includes a clamp 5 for clamping the pack 3 and a handle 70 attached to the clamp 5. The clamp 5 includes a first jaw 11 for contact with the top of the pack 3 and a second jaw 61 for contact with the bottom of the pack 3. The first jaw 11 is connected with the second jaw 61 so that a distance between them is adjustable. Thus, the clamp 5 can clamp packs of different heights. The handle 70 is attached to a plate 62 extending from the second jaw 61. It is easier to grip the handle 70 than to hold the pack 3.

A telescopic device is provided for connection the first jaw 11 with the second jaw 61 in the above-mentioned manner. The telescopic device includes a column 12 extending from the first jaw 11 and two rods 64 extending into the column 12 from the second jaw 61. The column 12 includes two tunnels 18 defined therein, a series of teeth 19 formed thereon and a stop 34 formed thereon. The rods 64 extend from a base 63 that is attached to the second jaw 61. On each of the rods 64 is mounted a compression spring 65. The rods 64 and the compression springs 65 are inserted in the tunnels 18. Thus, the first jaw 11 is connected with the second jaw 61 in a telescopic manner.

The first jaw 10 includes two restraints 17 formed thereon for restraining the pack 3. Similarly, the second jaw 61 includes restraints 66 and 67 formed thereon for restraining the pack 3. The base 63 includes a restraint for restraining the pack 3.

A locking device 80 is used to lock the plate 62 to the column 12. The locking device 80 includes a tongue 83 for engagement with one of the teeth 19, a spring 82 for biasing the tongue 83 and a switch 81 for operating the tongue 83. The handle 70 is hollow for receiving the spring 82 and the tongue 83. In the preferred embodiment, the handle 70 includes a first portion formed on the plate 62 and a second portion engaged with the first portion. The spring 82 and the tongue 83 are put in the handle 70 through an aperture (not numbered) defined in the plate 62. The switch 81 is put in an aperture (not shown) defined in the tongue 83 through a slot (not numbered) defined in the handle 70 and, more particularly, in the second portion of the handle 70.

The dispensing device includes a first piercing element 30 for piercing a first aperture in the top of the pack 3 and a second piercing element 31 for piecing a second aperture in the top of the pack 3. The beverage is poured from the pack 3 through the first aperture. The air pressure outside and inside the pack 3 is balanced because of the second aperture.

The first jaw 11 includes an aperture 14 defined therein for receiving the first piercing element 30, a second aperture 15 defined therein for receiving the second piercing element 31 and a corner shield 16 formed thereon for concealing the first piercing element 30.

A cover 20 is used to cover the first piercing element 30 and the second piercing element 31. The first jaw 10 includes two pivots 13 formed thereon. The cover 20 includes two clips 21 for clamping the pivots 13 so as to pivotally mount the cover 20 on the first jaw 10. A first seal 22 is attached to the cover 20 in order to seal the first piercing element 30. A second seal 23 is attached to the cover 20 in order to seal the second piercing element 31. The cover 20 includes an extension 25. When the cover 20 is put on the first jaw 10, the extension 25 extends beyond the first jaw 10. Thus, the cover 20 can easily be lifted via manipulating the extension 25.

A locking device 50 is used to lock the cover 20 to the first jaw 10. The first jaw 10 includes a slot 36 defined therein and a pivot 37 extending across the slot 36. The cover 20 defines a window 24 about which a reduced edge 26 is formed. The locking device 50 includes a lever 51 put in the slot 36, a clip 53 for clamping the pivot 37, a hook 54 for hooking the reduced edge 26, a press portion 55 extending beyond the cover 20 and a torque spring 56 arranged between the first jaw 10 and the lever 51.

A snap opening device 52 is used to snap open the cover 20 from the first jaw 10. The snap opening device 52 includes a spring 57 attached to the first jaw 10 and a sheath 58 mounted on the spring 57 in order to contact the cover 20.

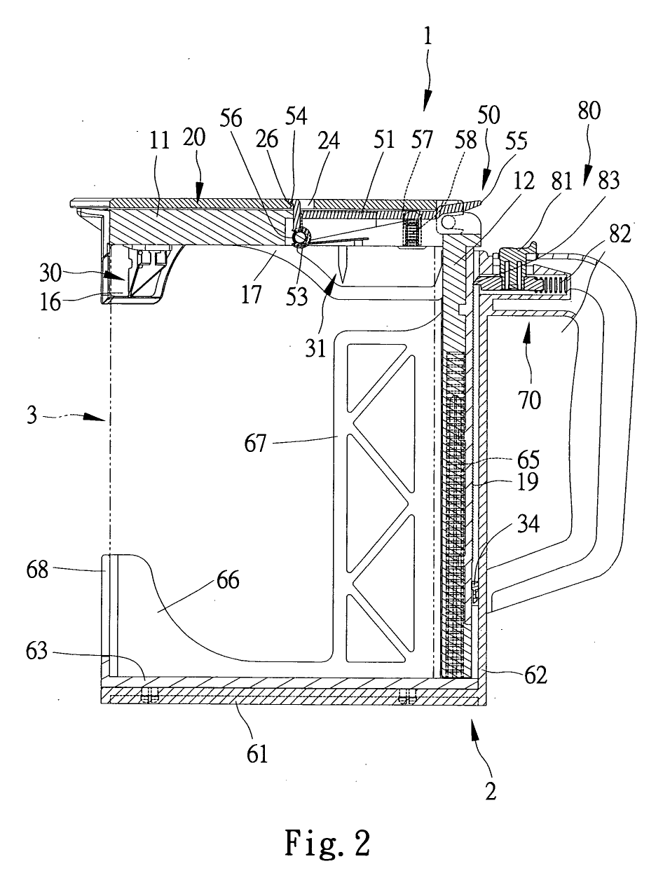

Referring to FIG. 2, the reduced edge 26 is hooked by means of the hook 54. Thus, the cover 20 is locked to the first jaw 10.

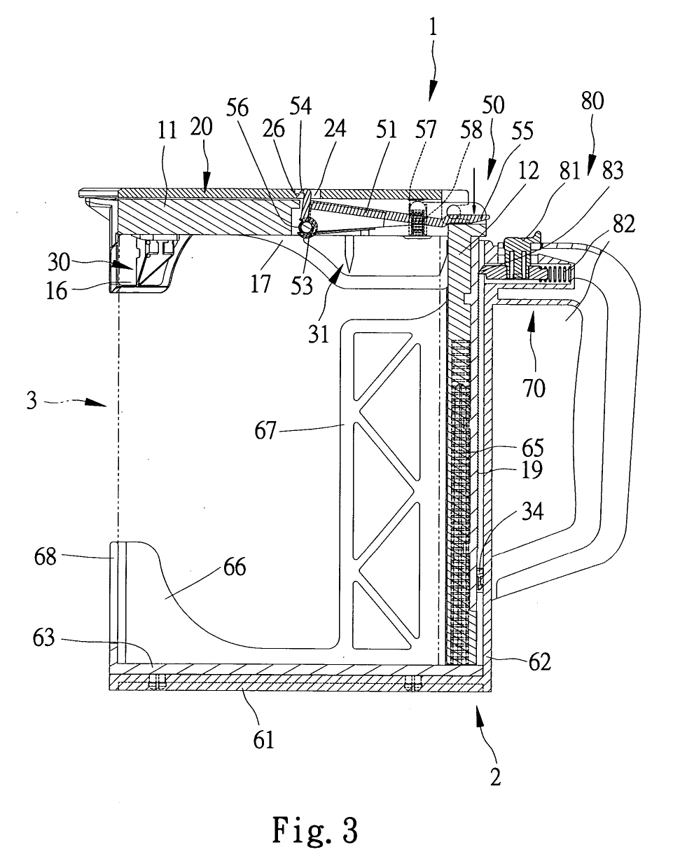

Referring to FIG. 3, via pressing the press portion 55, the lever 51 is pivoted and so is the hook 54. Thus, the reduced edge 26 is released from the hook 54.

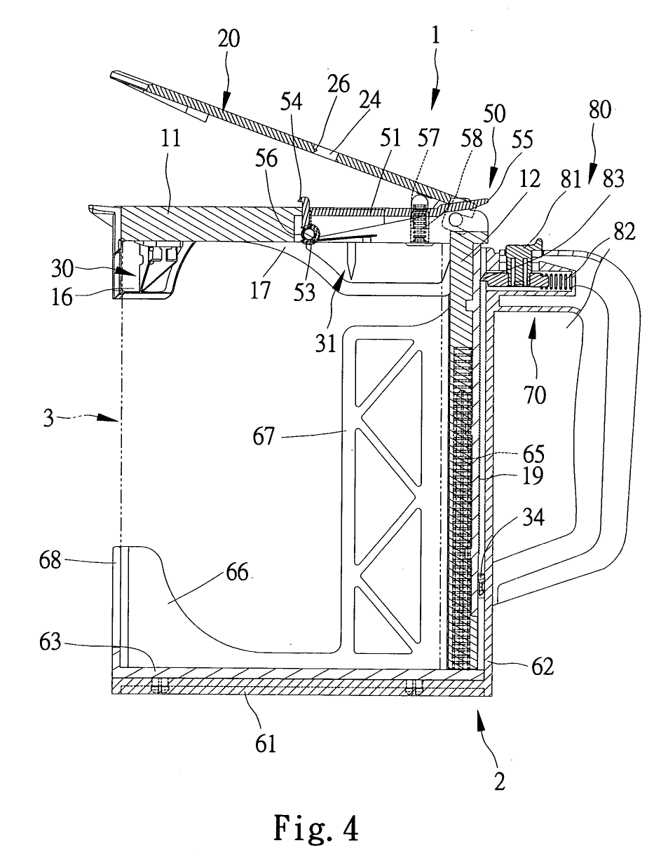

Referring to FIG. 4, the cover 20 is snap opened from the first jaw 10 by means of the snap opening device 52.

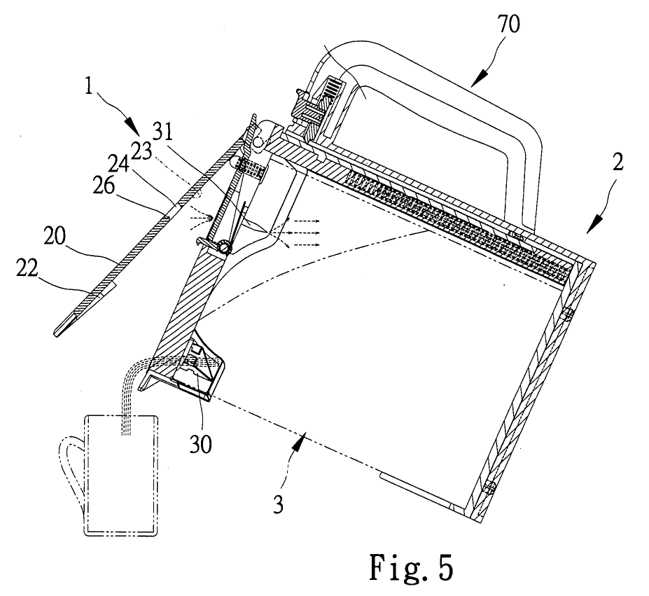

Referring to FIG. 5, the beverage is poured from the pack 3.

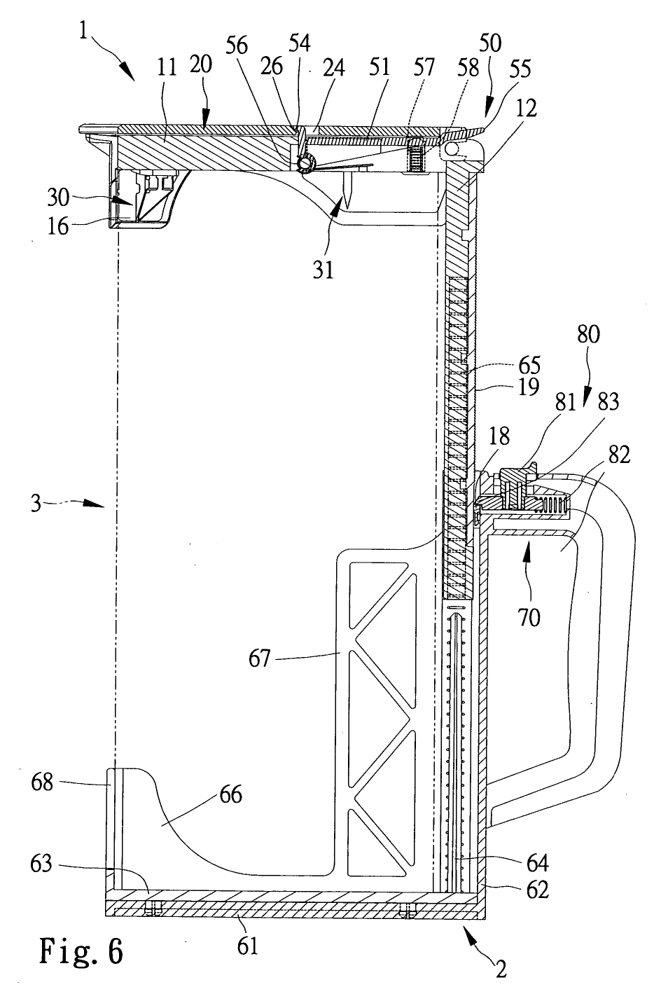

Referring to FIG. 6, via moving the switch 81, the tongue 83 is disengaged from the teeth 19. Thus, the first jaw 10 is movable from the second jaw 61.

The present invention has been described via detailed illustration of the preferred embodiment. Those skilled in the art can derive variations from the preferred embodiment without departing from the scope of the present invention. Therefore, the preferred embodiment shall not limit the scope of the present invention defined in the claims.

1. A holding and dispensing apparatus for use with a pack, the holding and dispensing apparatus comprising a holding device for holding the pack and a dispensing device for dispensing beverage from the pack.

2. The holding and dispensing apparatus according to claim 1 wherein the holding device includes a clamp for clamping the pack and a handle attached to the clamp.

3. The holding and dispensing apparatus according to claim 2 wherein the clamp includes a first jaw for contact with the top of the pack and a second jaw for contact with the bottom of the pack.

4. The holding and dispensing apparatus according to claim 3 wherein the clamp includes a plate extending from the second jaw in order to support the handle.

5. The holding and dispensing apparatus according to claim 4 wherein the first jaw is connected with the second jaw so that a distance between them is adjustable.

6. The holding and dispensing apparatus according to claim 5 wherein the clamp includes a telescopic device for connection the first jaw with the second jaw.

7. The holding and dispensing apparatus according to claim 6 wherein the telescopic device includes a column extending from the first jaw and two rods extending into the column from the second jaw.

8. The holding and dispensing apparatus according to claim 7 wherein the telescopic device includes two springs each mounted on related one of the rods.

9. The holding and dispensing apparatus according to claim 7 wherein the telescopic device includes a base attached to the second jaw and the rods extend from the base.

10. The holding and dispensing apparatus according to claim 7 including a locking device for locking the column to the plate.

11. The holding and dispensing apparatus according to claim 10 wherein the locking device includes a series of teeth formed on the column and a tongue movably mounted on the plate for engagement with one of the teeth.

12. The holding and dispensing apparatus according to claim 11 wherein the locking device includes a switch operatively connected with the tongue.

13. The holding and dispensing apparatus according to claim 12 wherein the locking device includes a spring for biasing the tongue against the plate.

14. The holding and dispensing apparatus according to claim 13 wherein the handle receives the spring and the tongue.

15. The holding and dispensing apparatus according to claim 14 wherein the handle includes a first portion formed on the plate and a second portion engaged with the first portion.

16. The holding and dispensing apparatus according to claim 3 wherein the first jaw includes two restraints formed thereon for restraining the pack.

17. The holding and dispensing apparatus according to claim 3 wherein the second jaw includes a restraint formed thereon for restraining the pack.

18. The holding and dispensing apparatus according to claim 9 wherein the base includes a restraint for restraining the pack.

19. The holding and dispensing apparatus according to claim 3 wherein the dispensing device includes a first piercing element attached to the first jaw for piercing a first aperture in the top of the pack and a second piercing element for piecing a second aperture in the top of the pack so that the beverage is poured from the pack through the first aperture, and that air pressure outside and inside the pack is balanced because of the second aperture.

20. The holding and dispensing apparatus according to claim 19 wherein the first jaw includes an aperture for receiving the first piercing element and a second aperture for receiving the second piercing element.

21. The holding and dispensing apparatus according to claim 20 wherein the first jaw includes a shield formed thereon for concealing the first piercing element.

22. The holding and dispensing apparatus according to claim 19 including a cover mounted on the first jaw covering the first piercing element and the second piercing element.

23. The holding and dispensing apparatus according to claim 22 wherein the cover is pivotally connected with the first jaw.

24. The holding and dispensing apparatus according to claim 23 wherein the first jaw includes two pivots formed thereon, and the cover includes two clips for clamping the pivots so as to pivotally connect the cover with the first jaw.

25. The holding and dispensing apparatus according to claim 22 including a first seal attached to the cover in order to seal the first piercing element and second seal attached to the cover in order to seal the second piercing element.

26. The holding and dispensing apparatus according to claim 23 wherein the cover includes an extension that extends beyond the first jaw when the cover is put on the first jaw so that the cover can easily be lifted via manipulating the extension.

27. The holding and dispensing apparatus according to claim 23 including a locking device for locking the cover to the first jaw.

28. The holding and dispensing apparatus according to claim 27 wherein the cover defines a window about which an edge is formed, and the locking device includes a lever pivotally mounted on the first jaw, a hook for hooking the edge, and a press portion extending beyond the cover.

29. The holding and dispensing apparatus according to claim 28 wherein the first jaw includes a slot for receiving the lever and a pivot extending across the slot, and the locking device includes a clip extending from the lever for clamping the pivot so as to pivotally mount the lever on the first jaw.

30. The holding and dispensing apparatus according to claim 28 wherein the locking device includes a torque spring arranged between the first jaw and the lever.

31. The holding and dispensing apparatus according to claim 27 including a snap opening device for snap opening the cover.

32. The holding and dispensing apparatus according to claim 31 wherein the snap opening device includes a spring attached to the first jaw for biasing the cover.

33. The holding and dispensing apparatus according to claim 32 wherein the snap opening device includes a sheath mounted on the spring in order to contact the cover.
